(19) United States
(12) Patent Application Publication
(10) Pub. No.: US 2025/0293337 A1
(43) Pub. Date: Sep. 18, 2025

(54) POWER STORAGE DEVICE

(71) Applicant: TOYOTA JIDOSHA KABUSHIKI KAISHA, Toyota-shi (JP)

(72) Inventors: Ryo MATSUDA, Nisshin-shi (JP); Taro MATSUSHITA, Toyokawa-shi (JP)

(73) Assignee: TOYOTA JIDOSHA KABUSHIKI KAISHA, Toyota-shi (JP)

(21) Appl. No.: 18/983,408

(22) Filed: Dec. 17, 2024

(30) Foreign Application Priority Data
Mar. 13, 2024 (JP) 2024-038920

(51) Int. Cl. H01M 10/653; H01M 10/613; H01M 10/658; H01M 50/209; H01M 50/293

(52) U.S. Cl. CPC H01M 10/653; H01M 10/613; H01M 10/658; H01M 50/293; H01M 50/209

(57) ABSTRACT

A power storage device includes power storage cells, a case, and heat conductive materials. The case includes a contact surface. The contact surface includes contact portions and a thermal resistance portion. The thermal resistance portion includes intermediate portions passing between a pair of contact portions adjacent to each other among the contact surfaces and extending in a second direction that intersects the first direction in the contact surface, a first connecting portion that connects an intermediate portion disposed odd-numbered from one side toward another side in the first direction and an intermediate portion disposed next to the intermediate portion disposed odd-numbered, and a second connecting portion that connects the intermediate portion disposed odd-numbered from one side toward the other side in the first direction and an intermediate portion disposed in front of the intermediate portion disposed odd-numbered.

### CROSS-REFERENCE TO RELATED APPLICATION

This application claims priority to Japanese Patent Application No. 2024-038920 filed on Mar. 13, 2024, incorporated herein by reference in its entirety.

### BACKGROUND

### 1. Technical Field

The present disclosure relates to a power storage device.

### 2. Description of Related Art

Japanese Unexamined Patent Application Publication No. 2023-149291 (JP 2023-149291 A) discloses a power storage device including a plurality of power storage elements and an exterior body. The exterior body includes a bottom wall, a pair of side walls, and a wall portion integrated with the bottom wall. The side walls face each other in a direction orthogonal to both the direction in which the power storage elements are arranged and the up-down direction. The wall portion is provided between a pair of adjacent power storage elements. The wall portion is spaced from the side walls.

Therefore, even when any of the power storage elements is overheated, the transfer of heat to the side walls via the wall portion adjacent to the power storage element is suppressed, and therefore the transfer of heat to the other power storage elements via the side walls is suppressed.

### SUMMARY

In the power storage device described in JP 2023-149291 A, there is a concern that when any of the power storage elements generates heat, the heat is transmitted to an adjacent power storage element via a portion (recessed portion) of the bottom wall between the wall portion and the side walls.

An object of the present disclosure is to provide a power storage device capable of suppressing heat conduction from one power storage cell to an adjacent power storage cell via a contact surface of a case.

One aspect of the present disclosure provides a power storage device including:
a plurality of power storage cells disposed side by side in a first direction;
a case that houses the power storage cells; and
a plurality of heat conductive materials provided between the respective power storage cells and the case, in which:
the case includes a contact surface in contact with the power storage cells via the heat conductive materials;
the contact surface includes
a plurality of contact portions in contact with the respective heat conductive materials, and
a thermal resistance portion having a thermal resistance greater than a thermal resistance of the contact portions;
the thermal resistance portion includes
intermediate portions that each pass between a pair of adjacent contact portions of the contact surface and that each extend in a second direction intersecting the first direction in the contact surface,
a first connecting portion that connects an intermediate portion disposed odd-numbered from one side toward another side in the first direction and an intermediate portion disposed next to the intermediate portion disposed odd-numbered, and
a second connecting portion that connects the intermediate portion disposed odd-numbered from one side toward the other side in the first direction and an intermediate portion disposed in front of the intermediate portion disposed odd-numbered;
the first connecting portion is provided at a position biased from a central portion of the contact surface in the second direction to one side in the second direction, and connects end portions of a pair of adjacent intermediate portions on one side in the second direction; and
the second connecting portion is provided at a position biased from the central portion of the contact surface in the second direction to the other side in the second direction, and connects end portions of a pair of adjacent intermediate portions on the other side in the second direction.

According to the present disclosure, it is possible to provide a power storage device capable of suppressing heat conduction from one power storage cell to an adjacent power storage cell via a contact surface of a case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically illustrating a power storage device according to an embodiment of the present disclosure;

FIG. 2 is a plan view schematically showing a case and a heat conductive material;

FIG. 3 is a cross-sectional view taken along III-III line in FIG. 1;

FIG. 4 is a cross-sectional view taken along IV-IV line in FIG. 1;

FIG. 5 is a cross-sectional view schematically illustrating a modification of the heat conductive material; and

FIG. 6 is a cross-sectional view schematically showing a modification of the contact portion of the case.

### DETAILED DESCRIPTION OF EMBODIMENTS

Embodiments of the present disclosure will be described with reference to the drawings. In the drawings referred to below, the same or corresponding members are denoted by the same reference numerals.

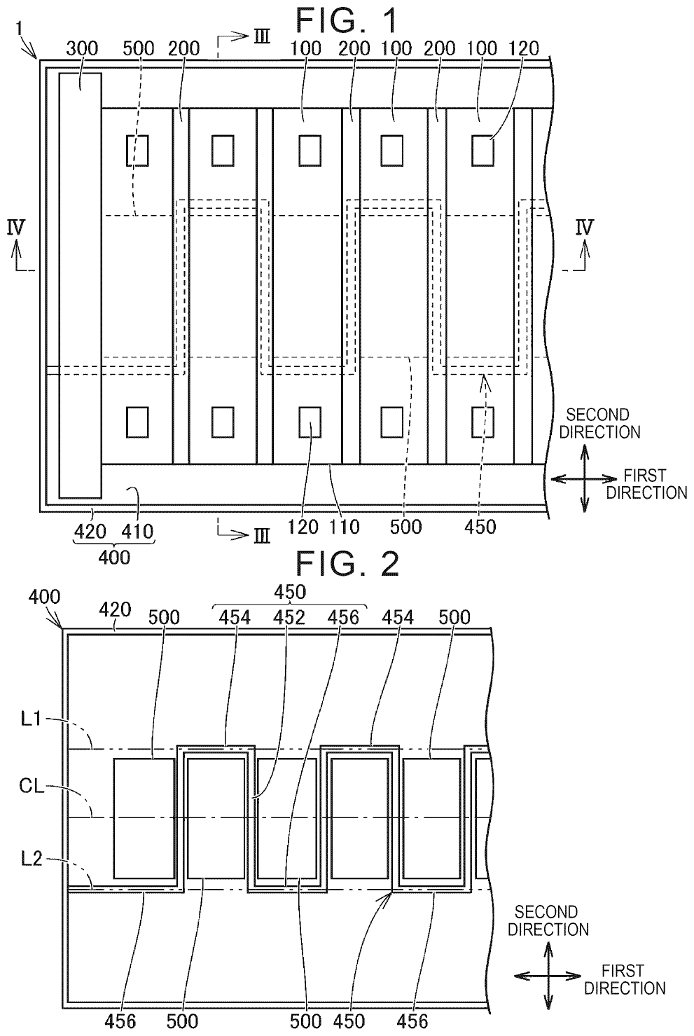

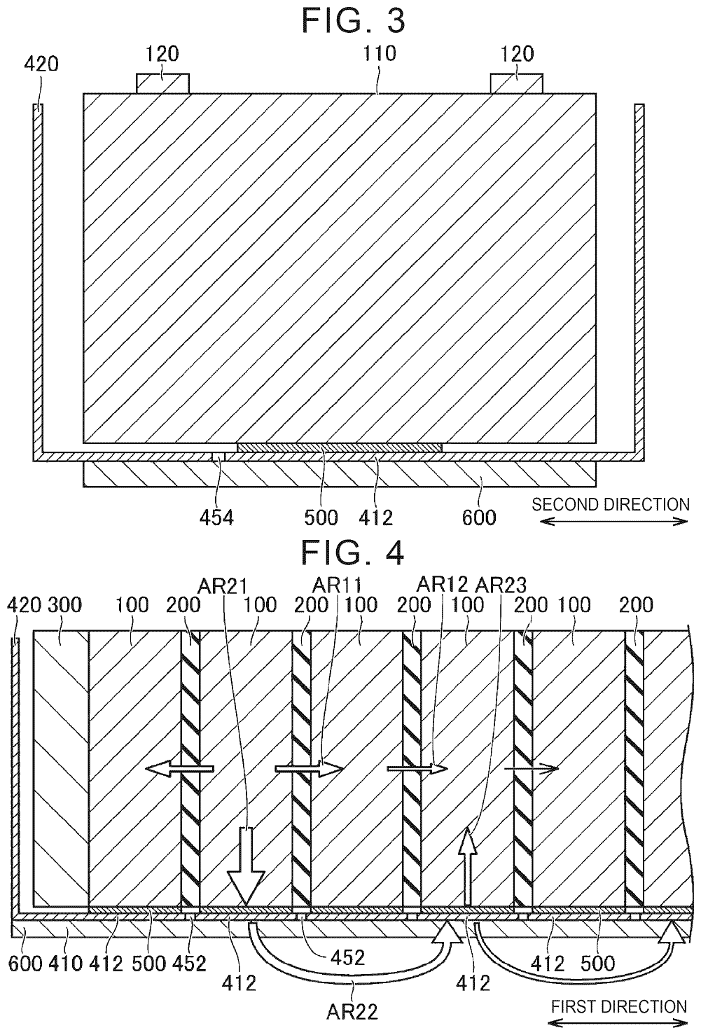

FIG. 1 is a plan view schematically illustrating a power storage device according to an embodiment of the present disclosure. FIG. 2 is a plan view schematically illustrating a case and a heat conductive material. FIG. 3 is a cross-sectional view taken along III-III line in FIG. 1. FIG. 4 is a cross-sectional view taken along IV-IV line in FIG. 1.

As illustrated in FIGS. 1 to 4, the power storage device 1 includes a plurality of power storage cells 100, a plurality of heat insulating materials 200, a pair of end plates 300, a case 400, a heat conductive material 500, and a cooler 600.

The plurality of power storage cells 100 are arranged side by side in the first direction. Each power storage cell 100 has a cell case 110 that houses an electrode assembly (not shown) and a pair of external terminals 120. As shown in FIGS. 1 and 3, the pair of external terminals 120 is provided on the upper surface of the cell case 110. In the present embodiment, the power storage cell 100 is formed of a so-called square cell.

Each heat insulating material 200 is disposed between a pair of power storage cells 100 adjacent to each other.

The pair of end plates 300 sandwich the plurality of power storage cells 100 from both sides in the first direction.

The case 400 houses a plurality of power storage cells 100, a plurality of heat insulating materials 200, and a pair of end plates 300. The case 400 opens upward. The case 400 has a bottom surface 410 and a peripheral wall 420.

The bottom surface 410 is disposed below the plurality of power storage cells 100. The bottom surface 410 is formed in a rectangular shape. The bottom surface 410 may be formed flat.

The peripheral wall 420 stands from the edge of the bottom surface 410. The peripheral wall 420 is formed in a quadrangular cylindrical shape that collectively surrounds the plurality of power storage cells 100.

The heat conductive material 500 is provided between each of the power storage cells 100 and the case 400. The heat conductive material 500 is made of an adhesive or the like having thermal conductivity. The heat conductive material 500 is in contact with the bottom surface 410 of the case 400 and the lower surface of each of the power storage cells 100. That is, the bottom surface 410 constitutes a “contact surface” in contact with each of the power storage cells 100 via the heat conductive material 500. Therefore, the bottom surface 410 is hereinafter referred to as a contact surface 410. Note that one surface of the peripheral wall 420 may constitute a contact surface. As illustrated in FIG. 4, a portion of the lower surface of each power storage cell 100 that is not in contact with the heat conductive material 500 is spaced apart from the bottom surface 410.

The contact surface 410 includes a contact portion 412 and a thermal resistance portion 450.

The contact portion 412 is a portion in contact with each of the power storage cells 100 via the heat conductive material 500.

The thermal resistance portion 450 has a thermal resistance greater than the thermal resistance of the contact portion 412. As shown in FIG. 2, the thermal resistance portion 450 is formed in a meandering shape (zigzag shape) while avoiding the heat conductive materials 500. The thermal resistance portion 450 includes a plurality of intermediate portions 452, a plurality of first connecting portions 454, and a plurality of second connecting portions 456.

Each of the intermediate portions 452 extends in a second direction passing between a pair of contact portions 412 adjacent to each other among the contact surfaces 410 and intersecting the first direction in the contact surface 410. In the present embodiment, the second direction is orthogonal to the first direction.

As shown in FIG. 4, the heat insulating material 200 is disposed at a position facing the intermediate portion 452 and spaced apart from the intermediate portion 452. Specifically, the heat insulating material 200 is disposed above the intermediate portion 452. The thickness of the heat insulating material 200 in the first direction is larger than the length of the intermediate portion 452 in the first direction.

Each of the first connecting portions 454 connects the intermediate portion 452 arranged in an odd number (for example, third) from one side toward the other side in the first direction, and the intermediate portion 452 arranged next (for example, fourth) to the intermediate portion 452. The first connecting portions 454 are provided at positions that 20 are biased from the center portion CL (see FIG. 2) of the contact surface 410 in the second direction to one side (the upper side in FIG. 2) in the second direction. Each of the first connecting portions 454 connects one end of the pair of intermediate portions 452 adjacent to each other in the second direction.

Each of the second connecting portions 456 connects the intermediate portion 452 arranged in an odd number (for example, third) from one side toward the other side in the first direction, and the intermediate portion 452 arranged in front of the intermediate portion 452 (for example, second). The second connecting portions 456 are provided at positions that are biased from the center portion CL of the contact surface 410 in the second direction toward the other side (lower side in FIG. 2) in the second direction. Each of the second connecting portions 456 connects end portions of the pair of intermediate portions 452 adjacent to each other on the other side in the second direction.

In the present embodiment, the intermediate portion 452, the first connecting portion 454, and the second connecting portion 456 are formed by slits that penetrate the contact surface 410 in the thickness direction thereof. However, the intermediate portion 452, the first connecting portion 454, and the second connecting portion 456 may have a thermal resistance larger than the thermal resistance of the contact portion 412, and may be formed to have a thickness smaller than the thickness of the contact portion 412, for example.

As shown in FIG. 2, the heat conductive materials 500 are provided only between the pair of intermediate portions 452 adjoining each other and between the first straight line L1 and the second straight line L2. The first straight line L1 is a virtual straight line formed by connecting the plurality of first connecting portions 454 to each other. The second straight line L2 is a virtual straight line formed by connecting the plurality of second connecting portions 456 to each other.

The cooler 600 is disposed so as to be in thermal contact with a contact surface (a lower surface in the present embodiment) of the case 400.

In the power storage device 1 described above, a case where a sudden heat generation occurs in any one of the power storage cells 100 will be described, and in the following, a case where a second power storage cell (hereinafter, referred to as a “heat generation cell”) from the left in FIG. 4 generates heat will be described. The thickness of each arrow shown in FIG. 4 indicates the magnitude of the amount of heat transferred.

Part of the heat generated in the heating cell is transmitted to one adjacent power storage cell (hereinafter, referred to as a “first adjacent cell”), as indicated by an arrow AR11, but since the heat insulating material 200 is disposed between the heating cell and the first adjacent cell, the amount of heat transmitted in AR11 of the arrow is reduced. Similarly, as indicated by the arrow AR12, the amount of heat transferred from the first adjacent cell to the two adjacent power storage cells (hereinafter, referred to as “second adjacent cells”) of the heating cell is further reduced.

On the other hand, a part of the heat generated in the heating cell is transmitted to the contact portion 412 through the heat conductive material 500 as indicated by the arrow AR21. In the present embodiment, since the pair of contact portions 412 are partitioned by the intermediate portion 452, the first connecting portion 454, and the second connecting portion 456, the heat transmitted in AR21 of the arrow is suppressed from being transmitted to the first neighboring cell via the contact portion 412.

The heat transferred from the heating cell to the contact portion 412 in AR21 indicated by the arrow is transferred to the contact portion 412 located below the second neighboring cell through the outer side of the second connecting portion 456 of the contact surface 410 of the case 400, as indicated by the arrow AR22. However, since the transfer distance of the heat is longer than the distance between the pair of contact portions 412 adjacent to each other, the amount of heat transferred from the heating cell to the second adjacent cell is relatively small. The heat transferred to the contact portion 412 below the second adjacent cell is transferred to the second adjacent cell through the heat conductive material 500 as shown by the arrow AR23.

As described above, in the power storage device 1 according to the present embodiment, heat conduction is suppressed from the heating cell via the contact surface 410 of the case 400 to the first adjacent cell.

The heat conductive materials 500 are provided only between the pair of intermediate portions 452 adjoining each other and between the first straight line L1 and the second straight line L2.

In this aspect, as shown in FIG. 3, since the distance from the heat conductive material 500 to each of the external terminals 120 is substantially equal, the temperature distribution in each of the power storage cells 100 is substantially uniform.

Hereinafter, a modification example of the above-described embodiment will be described.

### First Modification

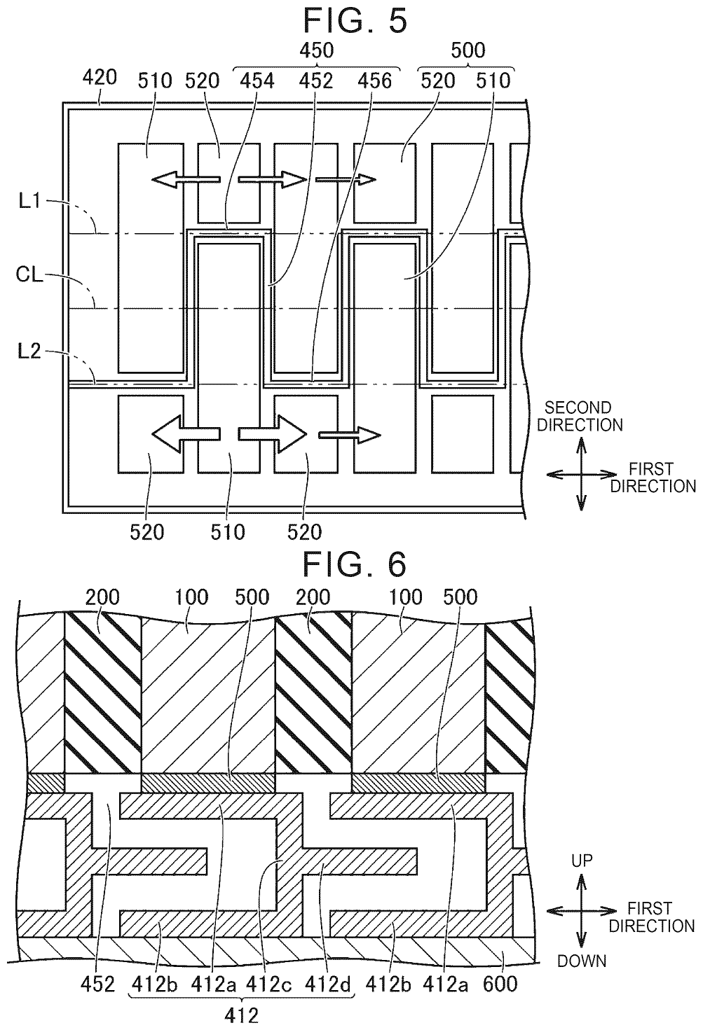

As shown in FIG. 5, each heat conductive material 500 may have a central element 510 and an outer element 520.

The central element 510 is provided between a pair of intermediate portions 452 adjacent to each other. The central element 510 facing the first connecting portion 454 in the second direction may extend to the outer side of the second straight line L2 in the second direction. The central element 510 facing the second connecting portion 456 in the second direction may extend to the outer side of the first straight line L1 in the second direction.

The outer element 520 is provided on the outside of the first connecting portion 454 in the second direction or on the outside of the second connecting portion 456 in the second direction.

The length of the outer element 520 in the second direction is smaller than the length of the central element 510 in the second direction.

In this aspect, in the steady state (when no sudden heat generation occurs in any of the power storage cells 100), each of the power storage cells 100 is effectively cooled by the cooler 600. Further, the first connecting portion 454 is provided at a position offset from the center portion CL of the contact surface 410 in the second direction toward one side in the second direction. Further, the second connecting portion 456 is provided at a position that is biased from the center portion CL of the contact surface 410 in the second direction toward the other side in the second direction. The length of the outer element 520 in the second direction is smaller than the length of the central element 510 in the second direction. Therefore, as indicated by an arrow in FIG. 5, heat generated in the heating cell is suppressed from being transferred to the power storage cell 100 adjacent to the power storage cell 100 via the outer element 520.

### Second Modification

As illustrated in FIG. 6, the contact portion 412 may have a labyrinth structure capable of restricting the gas discharged from the power storage cell 100 from flowing out of the case 400 via the intermediate portion 452. In the embodiment illustrated in FIG. 6, the contact portion 412 includes a support surface 412a, an opposing surface 412b, a coupling surface 412c, and a shielding surface 412d.

The support surface 412a supports the heat conductive material 500. The opposing surface 412b is opposed to the support surface 412a with a space therebetween. The coupling surface 412c connects the support surface 412a and the opposing surface 412b. The shielding surface 412d overlaps the intermediate portion 452 along the thickness of the contact surface 410. The shielding surface 412d extends between the support surface 412a and the opposing surface 412b in the contact portion 412 adjoining the contact portion 412 including the shielding surface 412d.

It will be understood by those skilled in the art that the exemplary embodiments and examples described above are illustrative of the following aspects.

### First Aspect

a plurality of power storage cells arranged side by side in a first direction; a case that houses the power storage cells; and
   A plurality of heat conductive materials each provided between the power storage cell and the case,
   The case includes a contact surface in contact with the power storage cell via the heat conductive material,
   The contact surface,
   A plurality of contact portions, each of which is in contact with the heat conductive material;
   A thermal resistance portion having a thermal resistance greater than the thermal resistance of the contact portion,
   The thermal resistance portion,
   An intermediate portion passing between a pair of adjacent contact portions of the contact surface and extending in a second direction intersecting the first direction in the contact surface,
   A first connecting portion connecting the intermediate portion disposed odd-numbered from one side toward the other side in the first direction and the intermediate portion disposed next to the intermediate portion,
   A second connecting portion connecting the intermediate portion disposed in an odd number from one side toward the other side in the first direction and the intermediate portion disposed in front of the intermediate portion,
   The first connecting portion is provided at a position which is biased from the central portion of the contact surface in the second direction to one side in the second direction, and connects the end portions of the pair of the intermediate portions adjacent to each other on one side in the second direction,
   The second connecting portion is provided at a position deviated from the central portion of the contact surface in the second direction to the other side in the second direction, and connects the other end of the pair of intermediate portions adjacent to each other in the second direction.

In this power storage device, a pair of contact portions in the contact surface of the case is partitioned by an intermediate portion, a first connecting portion, and a second connecting portion, so that even when one power storage cell generates heat, the heat is prevented from being transferred to an adjacent power storage cell through the contact portion.

On the other hand, heat generated in one power storage cell is transmitted to two adjacent power storage cells of one power storage cell through the outside of the first connecting portion or the outside of the second connecting portion of the contact surface of the case. However, since the transfer distance of the heat is longer than the distance between the pair of contact portions adjacent to each other, the amount of heat transferred from one power storage cell to two adjacent power storage cells is relatively small.

### Second Aspect

The power storage device according to aspect 1, wherein the intermediate portion, the first connecting portion, and the second connecting portion are each formed of a slit that penetrates the contact surface in a thickness direction thereof.

In this aspect, the intermediate portion, the first connecting portion, and the second connecting portion are effectively heat-shielded.

### Third Aspect

Each of the heat conductive materials is provided between a pair of the intermediate portions adjacent to each other, and a virtual first straight line formed by connecting the plurality of first connecting portions, and a virtual second straight line formed by connecting the plurality of second connecting portions, the power storage device according to aspect 1 or 2.

In this aspect, the temperature distribution in each power storage cell is substantially uniform.

### Fourth Aspect

A cooler disposed in thermal contact with the contact surface;
Each of the heat conductive material,
A central element provided between a pair of said intermediate portions adjacent to each other;
An outer element provided outside the first connecting portion in the second direction or outside the second connecting portion in the second direction,
The power storage device according to any one of aspects 1 and 2, wherein a length of the outer element in the second direction is smaller than a length of the central element in the second direction.

In this aspect, each power storage cell is effectively cooled by the cooler in a steady state (when no rapid heat generation occurs in any of the power storage cells). Further, the first connecting portion is provided at a position offset from the center of the contact surface in the second direction to one side in the second direction. Further, the second connecting portion is provided at a position that is biased from the center portion of the contact surface in the second direction to the other side in the second direction. The length of the outer element in the second direction is smaller than the length of the central element in the second direction. Therefore, even when a sudden heat generation occurs in any of the power storage cells, the transfer of heat to the power storage cells adjacent to the power storage cells via the outer element is suppressed.

### Fifth Aspect

The power storage device according to aspect 1, further comprising a plurality of heat insulating materials disposed between a pair of the power storage cells, each of which is adjacent to each other.

In this aspect, heat conduction from one power storage cell to the power storage cell adjacent to the power storage cell is suppressed more reliably.

### Sixth Aspect

The power storage device according to aspect 5, wherein the heat insulating material is disposed at a position opposed to the intermediate portion and spaced apart from the intermediate portion.

It should be understood that the embodiments disclosed herein are illustrative and non-restrictive in all respects. The scope of the present disclosure is defined by the terms of the claims, rather than the description of the embodiments described above, and includes all modifications within the scope and meaning equivalent to the terms of the claims.

What is claimed is:

1. A power storage device comprising:
a plurality of power storage cells disposed side by side in a first direction;
a case that houses the power storage cells; and
a plurality of heat conductive materials provided between the respective power storage cells and the case, wherein:
the case includes a contact surface in contact with the power storage cells via the heat conductive materials;
the contact surface includes
a plurality of contact portions in contact with the respective heat conductive materials, and
a thermal resistance portion having a thermal resistance greater than a thermal resistance of the contact portions;
the thermal resistance portion includes
intermediate portions that each pass between a pair of adjacent contact portions of the contact surface and that each extend in a second direction intersecting the first direction in the contact surface,
a first connecting portion that connects an intermediate portion disposed odd-numbered from one side toward another side in the first direction and an intermediate portion disposed next to the intermediate portion disposed odd-numbered, and
a second connecting portion that connects the intermediate portion disposed odd-numbered from one side toward the other side in the first direction and an intermediate portion disposed in front of the intermediate portion disposed odd-numbered;
the first connecting portion is provided at a position biased from a central portion of the contact surface in the second direction to one side in the second direction, and connects end portions of a pair of adjacent intermediate portions on one side in the second direction; and
the second connecting portion is provided at a position biased from the central portion of the contact surface in the second direction to the other side in the second direction, and connects end portions of a pair of adjacent intermediate portions on the other side in the second direction.

2. The power storage device according to claim 1, wherein the intermediate portions, the first connecting portion, and the second connecting portion are each constituted of a slit that penetrates the contact surface in a thickness direction of the contact surface.

3. The power storage device according to claim 1, wherein each of the heat conductive materials is provided only between a pair of adjacent intermediate portions and between a virtual first line formed by connecting a plurality of first connecting portions and a virtual second line formed by connecting a plurality of second connecting portions.

4. The power storage device according to claim 1, further comprising a cooler disposed in thermal contact with the contact surface, wherein:
each of the heat conductive materials includes
a central element provided between a pair of adjacent intermediate portions, and
an outer element provided on an outer side of the first connecting portion in the second direction or on an outer side of the second connecting portion in the second direction; and
a length of the outer element in the second direction is less than a length of the central element in the second direction.

5. The power storage device according to claim 1, further comprising a plurality of heat insulating materials each disposed between a pair of adjacent power storage cells, wherein the heat insulating materials are each disposed at a position facing the intermediate portions and away from the intermediate portions.
